(19) United States
(12) Patent Application Publication
(10) Pub. No.: US 2015/0380893 A1
(43) Pub. Date: Dec. 31, 2015

(54) LASER DEVICE, AND METHOD OF CONTROLLING ACTUATOR

(71) Applicant: Gigaphoton Inc., Tochigi (JP)

(72) Inventors: Takashi MATSUNAGA, Oyama-shi (JP); Takahito KUMAZAKI, Oyama-shi (JP); Keisuke ISHIDA, Oyama-shi (JP); Osamu WAKABAYASHI, Oyama-shi (JP)

(73) Assignee: GIGAPHOTON INC., Tochigi (JP)

(21) Appl. No.: 14/852,120

(22) Filed: Sep. 11, 2015

Related U.S. Application Data
(63) Continuation of application No. PCT/JP2014/063881, filed on May 26, 2014.

(30) Foreign Application Priority Data
May 27, 2013 (JP) 2013-111186

(51) Int. Cl. H01S 3/137; H01S 3/104; H01S 3/225

(52) U.S. Cl. CPC H01S 3/137; H01S 3/2251; H01S 3/2256; H01S 3/104

(57) ABSTRACT

A laser device (100) may include: a laser resonator (20, 30) configured to output pulsed laser light (L); an actuator (35, 36, 37) configured to change wavelength of the pulsed laser light; and a controller (110) configured to receive data of target wavelength for a plurality of pulses of the pulsed laser light before the pulsed laser light is output, and to control the actuator, based on the data of the target wavelength for the plurality of pulses, such that the wavelength of the pulsed laser light approaches the data of the target wavelength.

### CROSS-REFERENCE TO RELATED APPLICATIONS

This application is a continuation of PCT International Application No. PCT/JP2014/063881 filed on May 26, 2014 which claims the benefit of priority from Japanese Patent Application No. 2013-111186 filed on May 27, 2013, the entire contents of which are incorporated herein by reference.

### BACKGROUND OF THE INVENTION

1. Field of the Invention

The present disclosure relates to a laser device, and a method of controlling an actuator.

2. Description of the Related Art

As semiconductor integrated circuits have become miniaturized and highly integrated, improvement of resolution of semiconductor exposure devices has been demanded. Hereinafter, a semiconductor exposure device will simply be referred to as “exposure device”. Thus, attempts to shorten wavelength of light output from light sources for exposure have been made. Gas laser devices are used instead of conventional mercury lamps as the light sources for exposure. Presently, KrF excimer laser devices that output ultraviolet rays having a wavelength of 248 nm and ArF excimer laser devices that output ultraviolet rays having a wavelength of 193 nm are used as the gas laser devices for exposure.

Liquid immersion exposure has been implemented as a current exposure technique, which shortens an apparent wavelength of a light source for exposure, by a gap between a projection lens and a wafer at an exposure device side being filled with liquid and a refractive index in the gap being changed. If liquid immersion exposure is performed by using an ArF excimer laser device as a light source for exposure, a wafer is irradiated with ultraviolet light having a wavelength of 134 nm in water. This technique is called ArF liquid immersion exposure. The ArF liquid immersion exposure is also called ArF liquid immersion lithography.

Since a spectral line width of natural oscillation of KrF and ArF excimer laser devices is as wide as about 350 pm to 400 pm, chromatic aberration of laser light (ultraviolet light) reductively projected on a wafer by a projection lens at an exposure device side is caused and resolution is reduced. Thus, the spectral line width of the laser light output from the gas laser device needs to be narrowed until the chromatic aberration becomes negligible. The spectral line width is also called a spectral width. Thus, a line narrowing module having a line narrowing element is provided in a laser resonator of the gas laser device, and this line narrowing module realizes narrowing of the spectral width. The line narrowing element may be an etalon, a grating, or the like. A laser device with a narrowed spectral width is called a narrow-band laser device.

### SUMMARY

A laser device according to an embodiment of the disclosure may include a laser resonator (20, 30) configured to output pulsed laser light (L); an actuator (35, 36, 37) configured to change wavelength of the pulsed laser light; and a controller (110) configured to receive data of target wavelength for a plurality of pulses of the pulsed laser light before the pulsed laser light is output and to control the actuator, based on the data of the target wavelength for the plurality of pulses, such that the wavelength of the pulsed laser light approaches the data of the target wavelength.

A method of controlling an actuator (35, 36, 37) configured to change wavelength of pulsed laser light (L) according to an embodiment of the disclosure may include changing wavelength of the pulsed laser light dependently on a response time of the actuator prior to, by at least the response time, a time point at which target wavelength of the pulsed laser light is changed.

### BRIEF DESCRIPTION OF THE DRAWINGS

Hereinafter, some embodiments of the present disclosure will be described with reference to the appended drawings as mere examples.

FIG. 1 is a diagram exemplifying an outline of a configuration of a laser device according to an embodiment of the present disclosure;

FIG. 2 is a diagram exemplifying an outline of operation of the laser device according to the embodiment of the present disclosure;

FIG. 3 is a diagram exemplifying the configuration of the laser device according to the embodiment of the present disclosure;

FIG. 4 is a diagram exemplifying a configuration of a line narrowing module in the laser device according to the embodiment of the present disclosure;

FIG. 5 is a diagram exemplifying a configuration of a spectrometer in the laser device according to the embodiment of the present disclosure;

FIG. 6 is a diagram exemplifying a configuration of a controller in the laser device according to the embodiment of the present disclosure;

FIG. 7 is a diagram exemplifying problems of related art related to the laser device according to the embodiment of the present disclosure;

FIG. 8 is a diagram exemplifying an outline of a method of controlling wavelength of laser according to a first embodiment of the present disclosure;

FIG. 9 is a diagram exemplifying a flow chart of the method of controlling wavelength of laser according to the first embodiment of the present disclosure;

FIG. 10 is a diagram exemplifying data of target wavelength of pulsed laser light in the method of controlling wavelength of laser according to the first embodiment of the present disclosure;

FIG. 11 is a diagram exemplifying a subroutine for writing, into a storage unit, the data of target wavelength in the method of controlling wavelength of laser according to the first embodiment of the present disclosure;

FIG. 12 is a diagram exemplifying a first example of a wavelength control subroutine in the method of controlling wavelength of laser according to the first embodiment of the present disclosure;

FIG. 13 is a diagram exemplifying a second example of the wavelength control subroutine in the method of controlling wavelength of laser according to the first embodiment of the present disclosure;

FIG. 14 is a diagram exemplifying an outline of a method of controlling wavelength of laser according to a second embodiment of the present disclosure;

FIG. 15 is a diagram exemplifying a flow chart of the method of controlling wavelength of laser according to the second embodiment of the present disclosure;

FIG. 16 is a diagram exemplifying a subroutine for calculating and writing, into a storage unit, a delay pulse number in the method of controlling wavelength of laser according to the second embodiment of the present disclosure;

FIG. 17 is a diagram exemplifying a flow chart for an exposure device controller in a method of controlling wavelength of laser according to a third embodiment of the present disclosure; and

FIG. 18 is a diagram exemplifying a flow chart for a wavelength controller in the method of controlling wavelength of laser according to the third embodiment of the present disclosure.

### DETAILED DESCRIPTION OF THE PREFERRED EMBODIMENTS

Contents

1. Laser Device According to Embodiment of Present Disclosure

1.1 Outline of Laser Device According to Embodiment of Present Disclosure

1.2 Configuration Example of Laser Device According to Embodiment of Present Disclosure

1.3 Operation Example of Laser Device According to Embodiment of Present Disclosure

2. Problems of Related Art Related to Laser Device According to Embodiment of Present Disclosure

3. Method of Controlling Wavelength of Laser According to Embodiment of Present Disclosure

3.1 Method of Controlling Wavelength of Laser According to First Embodiment of Present Disclosure

3.2 Method of Controlling Wavelength of Laser According to Second Embodiment of Present Disclosure

3.3 Method of Controlling Wavelength of Laser According to Third Embodiment of Present Disclosure

Hereinafter, embodiments, which are described below with respect to embodiments of the present disclosure and which are described in detail with reference to the drawings, represent some examples of the present disclosure and do not limit substance of the present disclosure. Further, not all of configurations and operations described in the respective embodiments may be essential as configurations and operations of the present disclosure. The same reference signs will be appended to the same elements and any redundant description thereof will be omitted.

1. Laser Device According to Embodiment of Present Disclosure

1.1 Outline of Laser Device According to Embodiment of Present Disclosure

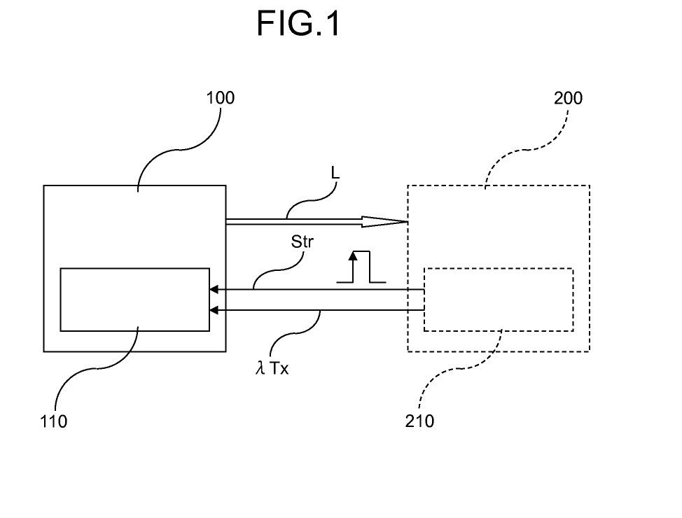

FIG. 1 is a diagram exemplifying an outline of a configuration of a laser device according to an embodiment of the present disclosure.

A laser device 100 may be configured to emit pulsed laser light L. The laser device 100 may include a laser controller 110. The laser device 100 may be a laser device for an exposure device, the laser device being used with an exposure device 200.

The exposure device 200 may be a semiconductor exposure device. The exposure device 200 may be configured to expose a wafer provided in the exposure device 200 to the pulsed laser light L emitted from the laser device 100. The exposure device 200 may include an exposure device controller 210. The laser controller 110 may be connected to the exposure device controller 210 via a line. The exposure device controller 210 may include an arithmetic processing device that performs arithmetic processing, a storage device that stores data, and a timer that measures time.

The laser controller 110 may receive an emission trigger signal Str and target wavelength λtx from the exposure device controller 210.

The laser controller 110 may control the laser device 100 such that wavelength of the pulsed laser light L emitted from the laser device 100 becomes the target wavelength λtx.

The laser controller 110 may control the laser device 100 such that the laser device 100 is synchronized with the emission trigger signal Str and emits the pulsed laser light L having wavelength that is the same as or close to the target wavelength λtx.

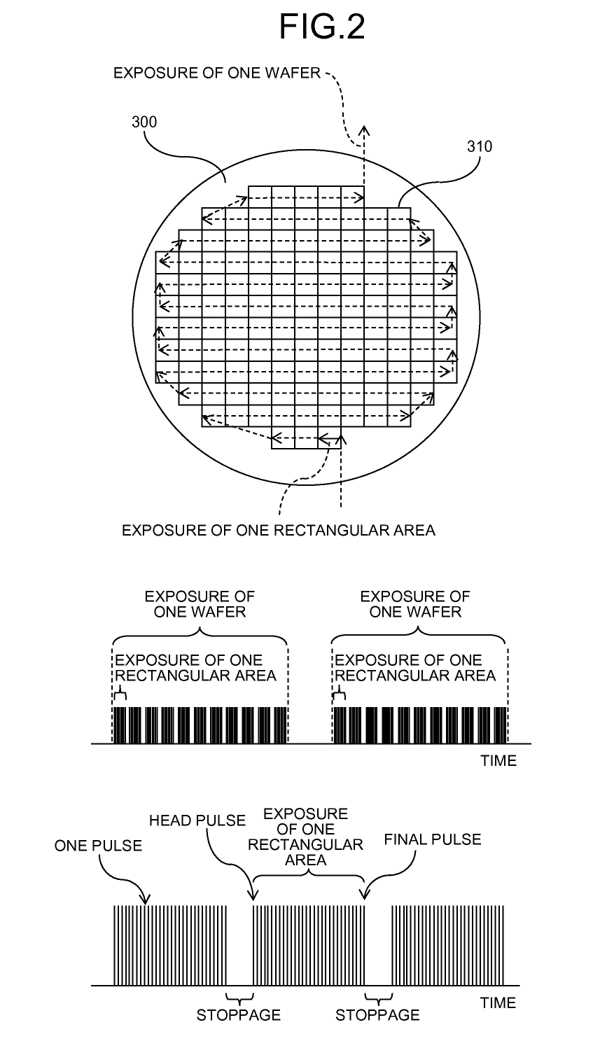

FIG. 2 is a diagram exemplifying an outline of operation of the laser device according to the embodiment of the present disclosure.

As exemplified in FIG. 2, the laser device 100 exemplified in FIG. 1 may expose a wafer 300 provided in the exposure device 200 to pulsed laser light via the exposure device 200 exemplified in FIG. 1. The laser device 100 may, for example, expose the wafer 300 to pulsed laser light for each of a plurality of rectangular areas 310 set on the wafer 300. The laser device 100 may sequentially scan the plurality of rectangular areas 310 on the wafer 300 with pulsed laser light as illustrated with arrowed lines in FIG. 2, for example. After exposing one wafer 300 to laser light, the laser device 100 may expose the next wafer 300 to laser light.

As exemplified in FIG. 2, when one wafer 300 is exposed to laser light, each of the rectangular areas 310 may be exposed to pulsed laser light with pulses having a predetermined repetition frequency (for example, 6 kHz) and a predetermined count (for example, several hundred pulses). Between exposure of one rectangular area 310 and exposure of the next rectangular area 310, exposure to pulsed laser light may be stopped for a predetermined time interval (for example, of equal to or greater than 0.1 second to 0.2 second). Stopping exposure to pulsed laser light at predetermined time intervals and executing exposure to pulsed laser light with pulses of a predetermined repetition frequency and a predetermined count may be called burst mode operation. When the laser device 100 is in burst mode operation, as exemplified in FIG. 2, exposure to pulsed laser light from a head pulse to a final pulse may be called a burst.

The exposure device controller 210 included in the exposure device 200 may transmit the emission trigger signal Str to the laser controller 110 included in the laser device 100 such that the laser device 100 executes the burst mode operation. Thereby, the laser device 100 is able to execute the burst mode operation.

1.2 Configuration Example of Laser Device According to Embodiment of Present Disclosure

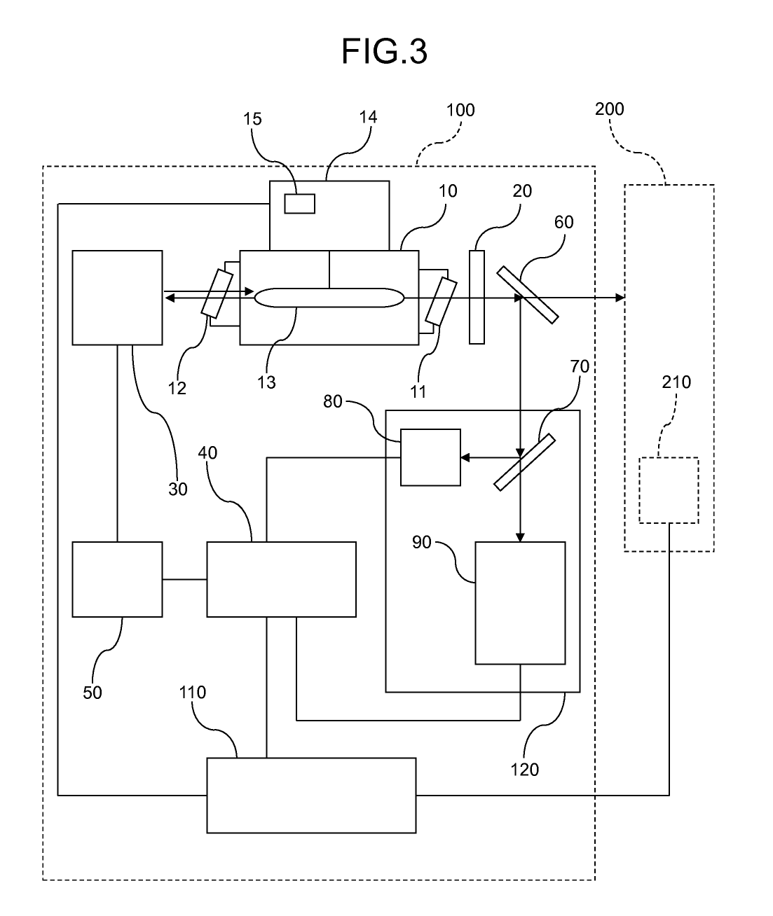

FIG. 3 is a diagram exemplifying a configuration example of the laser device according to the embodiment of the present disclosure. Straight lines without arrows in FIG. 3 represent electric connection among elements. Arrowed straight lines in FIG. 3 represent traveling directions of laser light.

The laser device exemplified in FIG. 3 may be a narrow-band laser device 100 that is able to control wavelength of laser light. The narrow-band laser device 100 may be a laser device used with an external device. The external device may be the exposure device 200. The exposure device 200 may include the exposure device controller 210.

The narrow-band laser device 100 may be an excimer laser device. The excimer laser device may be an argon fluoride (ArF) excimer laser device or a krypton fluoride (KrF) excimer laser device. The narrow-band laser device 100 may be a variable wavelength ultraviolet solid-state laser device. The variable wavelength ultraviolet solid-state laser device may be, for example, a solid-state laser device having titanium-sapphire laser combined with nonlinear crystal.

The narrow-band laser device 100 may be a single-stage narrow-band ultraviolet laser. The narrow-band laser device 100 may be installed in a double-stage laser system. For example, the narrow-band laser device 100 may be installed, as a master oscillator (MO), in a power amplifier (PA) that amplifies laser light. For example, the narrow-band laser device 100 may be installed, as a master oscillator (MO), in a power oscillator (PO).

The narrow-band laser device 100 may include the laser controller 110. The narrow-band laser device 100 may include a laser chamber 10, an output coupling mirror 20, a line narrowing module (LNM) 30, a wavelength controller 40, and a driver 50. The narrow-band laser device 100 may include a first beam splitter 60 and a wavelength measuring unit 120. The output coupling mirror 20 and the line narrowing module 30 may form a laser resonator of the narrow-band laser device 100, the laser resonator being configured to output laser light.

The laser chamber 10 may be provided on an optical path of the laser resonator. The laser chamber 10 may include a first window 11, a second window 12, a pair of electrodes 13, and a power source 14.

The laser chamber 10 may include a laser medium. If the narrow-band laser device 100 is the ArF excimer laser device, the laser medium may be a gas mixture including argon (Ar) gas, fluorine (F₂) gas, and neon (Ne) gas. If the narrow-band laser device 100 is the KrF excimer laser device, the laser medium may be a gas mixture including krypton (Kr) gas, fluorine (F2) gas, and neon (Ne) gas.

The first window 11 and the second window 12 may be provided to allow laser light to pass therethrough.

The pair of electrodes 13 may be provided oppositely in a direction perpendicular with respect to a paper surface of FIG. 3 in the laser chamber 10. The pair of electrodes 13 may be provided such that a longitudinal direction of the electrodes 13 coincides with a direction of the optical path of the laser resonator.

The power source 14 may be connected to the pair of electrodes 13. The power source 14 may include a power switch 15. The power switch 15 may be configured to turn the power source 14 on or off according to output of the laser controller 110. The power source 14 may be configured to apply voltage to the pair of electrodes 13 when the power switch 15 is turned on.

The output coupling mirror 20 may be coated with a film that reflects a part of laser light and lets another part of the laser light penetrate therethrough.

The line narrowing module 30 may be configured to narrow a width (spectral width) of wavelength of laser light.

The first beam splitter 60 may be provided on an optical path of laser light output from the output coupling mirror 20. The first beam splitter 60 may be provided to let a part of the laser light output from the output coupling mirror 20 penetrate therethrough to the exposure device 200. The first beam splitter 60 may be provided such that another part of the laser light is reflected towards the wavelength measuring unit 120.

The wavelength measuring unit 120 may be configured to measure wavelength of pulsed laser light. The wavelength measuring unit 120 may include a second beam splitter 70, an optical sensor 80, and a spectrometer 90.

The second beam splitter 70 may be provided on an optical path of the laser light reflected by the first beam splitter 60. The second beam splitter 70 may be provided to let a part of the laser light reflected by the first beam splitter 60 penetrate therethrough to the spectrometer 90. The second beam splitter 70 may be provided to reflect another part of the laser light reflected by the first beam splitter 60 towards the optical sensor 80.

The optical sensor 80 may be provided to detect the laser light reflected by the second beam splitter 70. Output of the optical sensor 80 may be transmitted to the wavelength controller 40. The optical sensor 80 may be connected to the wavelength controller 40.

The spectrometer 90 may be provided to receive the laser light that has penetrated through the second beam splitter 70. The spectrometer 90 may be configured to measure wavelength of laser light. The spectrometer 90 may be able to measure wavelength of laser light for each laser pulse. Output of the spectrometer 90 may be transmitted to the wavelength controller 40. The spectrometer 90 may be connected to the wavelength controller 40.

The wavelength controller 40 may be configured to receive the output of the optical sensor 80 included in the wavelength measuring unit 120. The wavelength controller 40 may be connected to the optical sensor 80 included in the wavelength measuring unit 120. The wavelength controller 40 may be configured to receive the output of the spectrometer 90 included in the wavelength measuring unit 120. The wavelength controller 40 may be connected to the spectrometer 90 included in the wavelength measuring unit 120. The wavelength controller 40 may be configured to receive output of the laser controller 110 and to transmit output of the wavelength controller 40 to the laser controller 110. The wavelength controller 40 may be connected to the laser controller 110. The wavelength controller 40 may be configured to transmit output of the wavelength controller 40 to the driver 50. The wavelength controller 40 may be connected to the driver 50. The wavelength controller 40 may include an arithmetic processing unit that executes arithmetic processing. The wavelength controller 40 may include a storage unit that stores results of arithmetic processing executed by the arithmetic processing unit. The wavelength controller 40 may include a timer that measures time.

The laser controller 110 may be configured to receive output of the exposure device controller 210 included in the exposure device 200. The laser controller 110 may be connected to the exposure device controller 210 included in the exposure device 200. The laser controller 110 may be configured to receive output of the wavelength controller 40 and to transmit output of the laser controller 110 to the wavelength controller 40. The laser controller 110 may be configured to transmit output of the laser controller 110 to the power source 14. The laser controller 110 may be connected to the power source 14.

The driver 50 may be configured to control the line narrowing module 30. The driver 50 may be configured to receive output of the wavelength controller 40 and to transmit output of the driver 50 to the line narrowing module 30. The driver 50 may be connected to the line narrowing module 30 and the wavelength controller 40.

At least two of the laser controller 110, the wavelength controller 40, and the driver 50 in the narrow-band laser device 100 exemplified in FIG. 3 may be integrated together.

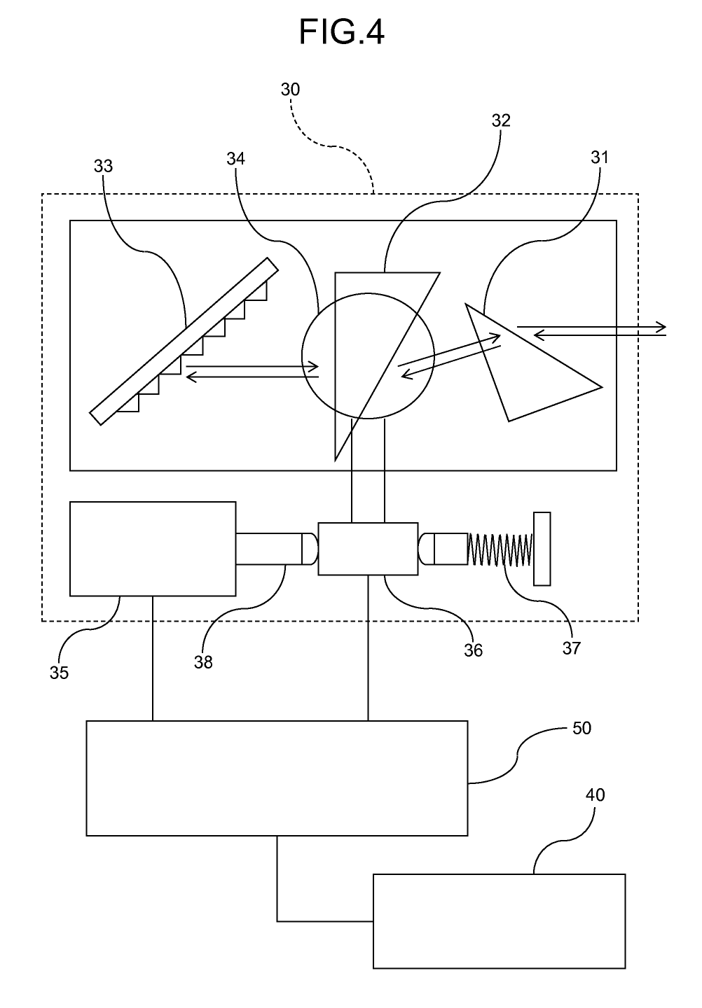

FIG. 4 is a diagram exemplifying a configuration of the line narrowing module in the laser device according to the embodiment of the present disclosure.

The line narrowing module 30 may include a plurality of prisms (for example, two prisms including a first prism 31 and a second prism 32), a grating 33, and a rotary stage 34. The driver 50 may be provided to control rotation of the rotary stage 34 included in the line narrowing module 30, according to output from the wavelength controller 40.

The first prism 31 and the second prism 32 may be provided to function as a beam expander. The second prism 32 may be provided on the rotary stage 34.

The grating 33 may be provided, so that a diffraction angle of laser light completely or substantially coincides with an incident angle of the laser light, that is, in a Littrow arrangement.

The rotary stage 34 may be configured to rotate the second prism 32. The rotary stage 34 may be provided such that, by rotating the second prism 32, an incident angle of laser light of a certain wavelength on the grating 33 is changed. The rotary stage 34 may be configured to rotate the first prism 31 or the grating 33, instead of the second prism 32. Instead of the second prism 32, the first prism 31 or the grating 33 may be provided on the rotary stage 34.

The line narrowing module 30 may include a micrometer 35 with a pulse motor (stepping motor), a piezoelectric element 36, and a reaction spring member 37. The micrometer 35 with a pulse motor (stepping motor), the piezoelectric element 36, and the reaction spring member 37 may form an actuator that drives the rotary stage 34 included in the line narrowing module 30. The actuator may be configured to change wavelength of pulsed laser light.

The micrometer 35 may be configured to receive a signal from the driver 50 and apply a load on the piezoelectric element 36. The micrometer 35 may be connected to the driver 50. The driver 50 may include a power source for driving the pulse motor (stepping motor) of the micrometer 35, according to output from the wavelength controller 40.

The piezoelectric element 36 may be provided at a distal end of a micrometer head 38 of the micrometer 35. The piezoelectric element 36 may be configured to rotate the rotary stage 34 according to the load applied by the micrometer 35. The piezoelectric element 36 may be connected to the driver 50. The driver 50 may include a power source for applying voltage to the piezoelectric element 36 and deforming the piezoelectric element 36, according to output from the wavelength controller 40. The piezoelectric element 36 may be configured to be deformed, and to rotate the rotary stage 34, according to the applied voltage.

The reaction spring member 37 may be configured to apply a reactive force on the piezoelectric element 36 so as to stop the piezoelectric element 36 against the load applied on the piezoelectric element 36 from the micrometer 35.

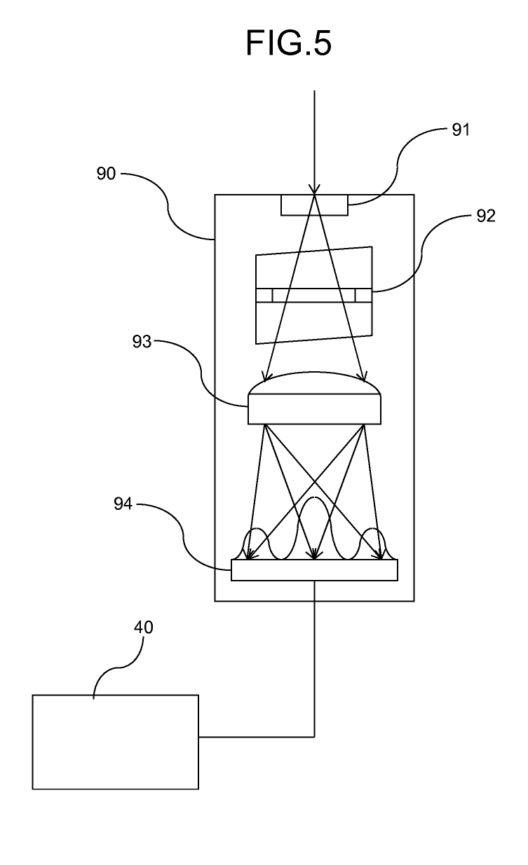

FIG. 5 is a diagram exemplifying a configuration of the spectrometer in the laser device according to the embodiment of the present disclosure.

The spectrometer 90 may be an etalon spectrometer. The spectrometer 90 may include a diffusion element 91, a monitor etalon 92, a condenser lens 93, and an image sensor 94. In the spectrometer 90, the diffusion element 91, the monitor etalon 92, the condenser lens 93, and the image sensor 94 may be provided in this order.

The diffusion element 91 may be provided to diffuse laser light that has penetrated through the second beam splitter 70.

The monitor etalon 92 may be, for example, an air gap etalon. The monitor etalon 92 may be provided to receive the laser light diffused by the diffusion element 91 and to cause interference with the laser light diffused by the diffusion element 91.

The condenser lens 93 may be configured to condense the laser light that has penetrated through the monitor etalon 92 onto the image sensor 94.

The image sensor 94 may be, for example, a line sensor such as a one-dimensional CCD, or a photodiode array. The image sensor 94 may be provided on a focal plane of the condenser lens 93. An interference fringe of the laser light that has penetrated through the monitor etalon 92 may be generated on the focal plane of the condenser lens 93. The image sensor 94 may detect the interference fringe of the laser light that has penetrated through the monitor etalon 92.

A square of a radius of the interference fringe generated on the focal plane of the condenser lens 93 may be proportional to wavelength of the laser light. Wavelength λ of laser light may be expressed by the following equation.

λ=λc+αr²

In the equation, “r” is the radius of the interference fringe of the detected laser light. Further, “λc” is a wavelength at which an optical intensity of the interference fringe of the detected laser light becomes maximum. Furthermore, “α” is a proportional constant.

A spectral profile of the laser light may be detected from the interference fringe of the laser light detected by the image sensor 94. A center wavelength of a spectral line of the laser light and a width of the spectral line may be detected from the interference fringe of the laser light detected by the image sensor 94. The center wavelength of the spectral line of the laser light and the width of the spectral line may be detected by an information processing device not exemplified in the figures and may be calculated by the wavelength controller 40.

The spectrometer 90 may include a plurality of etalon spectrometers having different free spectral ranges.

The spectrometer 90 may be a spectrometer including a grating and an image sensor. The grating may be provided to diffract light that has penetrated through the second beam splitter 70. A spectral profile of the laser light diffracted by the grating may be detected by the image sensor. A center wavelength of a spectral line of the laser light and a width of the spectral line may be detected by the image sensor. The center wavelength of the spectral line of the laser light and the width of the spectral line may be detected by an information processing device not exemplified in the figures and may be calculated by the wavelength controller 40.

The wavelength controller 40 may be configured to control, based on wavelength of laser light measured by the wavelength measuring unit 120, an actuator included in the line narrowing module 30.

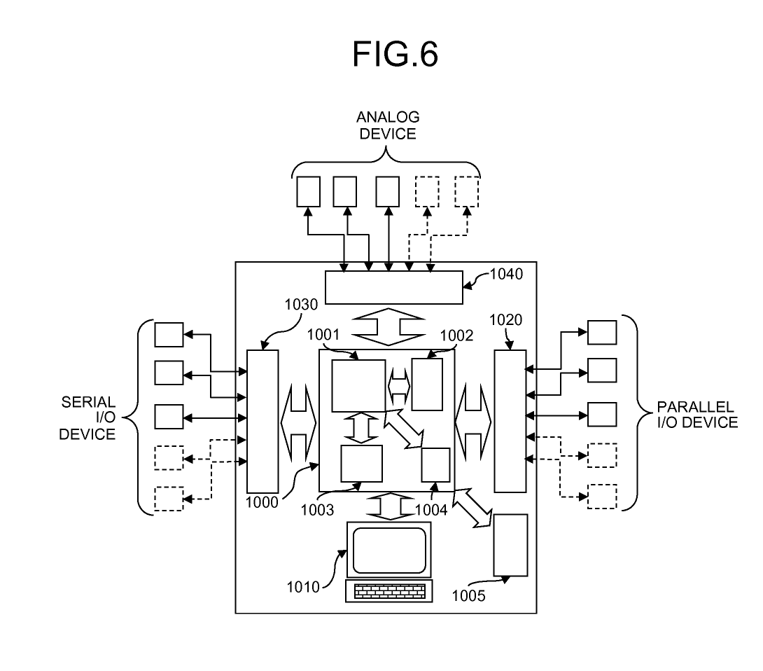

FIG. 6 is a diagram exemplifying a configuration of a controller in the laser device according to the embodiment of the present disclosure.

Each of the above-described controllers according to the embodiment may be configured of a general-purpose control device, such as a computer or a programmable controller. For example, the following configuration may be adopted.

The controller may be configured of: a processing unit 1000; and a storage memory 1005, a user interface 1010, a parallel I/O controller 1020, a serial I/O controller 1030, and an A/D D/A converter 1040, which are connected to the processing unit 1000. The processing unit 1000 may be configured of: a CPU 1001; and a memory 1002, a timer 1003, and a GPU 1004, which are connected to the CPU 1001.

The processing unit 1000 may read out a program stored in the storage memory 1005. Further, the processing unit 1000 may execute the read out program, read out data from the storage memory 1005 according to the execution of the program, and store the data into the storage memory 1005.

The parallel I/O controller 1020 may be connected to a device communicatable via a parallel I/O port. The parallel I/O controller 1020 may control communication of digital signals via the parallel I/O port performed in the execution of the program by the processing unit 1000.

The serial I/O controller 1030 may be connected to a device communicatable via a serial I/O port. The serial I/O controller 1030 may control communication of digital signals via the serial I/O port performed in the execution of the program by the processing unit 1000.

The A/D D/A converter 1040 may be connected to a device communicatable via an analog port. The A/D D/A converter 1040 may control communication of analog signals via the analog port performed in the execution of the program by the processing unit 1000.

The user interface 1010 may be configured to display, to an operator, the process of the execution of the program by the processing unit 1000 and to cause the processing unit 1000 to perform stoppage or interruption processing of the execution of the program by the operator.

The CPU 1001 of the processing unit 1000 may perform arithmetic processing of the program. In the process of the execution of the program by the CPU 1001, the memory 1002 may temporarily store the program or temporarily store data in the process of the calculation. The timer 1003 may measure time and elapsed time, and may output the time and elapsed timed to the CPU 1001 according to the execution of the program. The GPU 1004 may process image data according to the execution of the program when the image data are input to the processing unit 1000, and may output a result thereof to the CPU 1001.

The device connected to the parallel I/O controller 1020 and communicatable via the parallel I/O port may be the optical sensor 80, the image sensor 94, another controller, or the like.

The device connected to the serial I/O controller 1030 and communicatable via the serial I/O port may be another controller, or the like.

The device connected to the A/D D/A converter 1040 and communicatable via the analog port may be the optical sensor 80, the image sensor 94, or the like.

1.3 Operation Example of Laser Device According to Embodiment of Present Disclosure

An operation example of the laser device according to the embodiment of the present disclosure will be described based on FIG. 1, FIG. 3, FIG. 4, and FIG. 5.

The exposure device controller 210 included in the exposure device 200 may transmit data of target wavelength λtx of laser light and an emission trigger signal Str to the laser controller 110 included in the laser device 100.

The laser controller 110 may transmit the emission trigger signal Str received from the exposure device controller 210 to the power source 14. The laser controller 110 may transmit the data of the target wavelength λtx received from the exposure device controller 210 to the wavelength controller 40.

The power source 14 may be synchronized with the emission trigger signal Str received from the laser controller 110 and turn the power switch 15 included in the power source 14 on or off. When the power switch 15 is turned on, voltage may be applied between the pair of electrodes 13 included in the laser chamber 10. When the voltage is applied between the pair of electrodes 13, electric discharge of the laser medium included in the laser chamber 10 may be caused and pulsed laser light may be generated from the laser medium by stimulated emission. The pulsed laser light generated from the laser medium may travel and be amplified, through the first window 11 and the second window 12, between the output coupling mirror 20 and the line narrowing module 30 forming the laser resonator. A part of the amplified pulsed laser light may penetrate through the output coupling mirror 20. A part of the pulsed laser light that has penetrated through the output coupling mirror 20 may be incident on the first beam splitter 60. A part of the light incident on the first beam splitter 60 may penetrate through the first beam splitter 60 and be input to the exposure device 200 (laser oscillation).

The line narrowing module 30 may receive pulsed laser light generated from the laser medium, through the second window 12. The line narrowing module 30 may generate narrowed pulsed laser light by spectrally dispersing the received pulsed laser light with respect to wavelength of the pulsed laser light, by the first prism 31, the second prism 32, and the grating 33. The line narrowing module 30 may rotate the second prism 32 by rotating the rotary stage 34 according to output of the driver 50. The line narrowing module 30 may change the incident angle of the pulsed laser light incident on the grating 33 by rotating the second prism 32. By changing the incident angle of the pulsed laser light incident on the grating 33, wavelength of pulsed laser light diffracted by the grating 33 and reflected towards the laser chamber 10 may be selected (the pulsed laser light may be narrowed). The wavelength of the pulsed laser light may be selected according to the incident angle of the pulsed laser light with respect to the grating 33 and the diffraction angle of the pulsed laser light with respect to the grating 33.

The rotary stage 34 included in the line narrowing module 30 may be driven by the micrometer 35 controlled according to output of the driver 50. The rotary stage 34 included in the line narrowing module 30 may be driven by the piezoelectric element 36 controlled according to output of the driver 50. The rotary stage 34 may improve a response time of the rotary stage 34 with respect to the output of the driver 50 by being driven by the piezoelectric element 36 in addition to the micrometer 35.

A part of the pulsed laser light reflected by the first beam splitter 60 may be input to the wavelength measuring unit 120.

The pulsed laser light input to the wavelength measuring unit 120 may be incident on the second beam splitter 70.

A part of the pulsed laser light incident on the second beam splitter 70 may be reflected to the optical sensor 80. The optical sensor 80 may receive the pulsed laser light reflected to the optical sensor 80 and transmit a detection signal for the pulsed laser light to the wavelength controller 40.

A part of the pulsed laser light incident on the second beam splitter 70 may penetrate through the second beam splitter 70 and be incident on the spectrometer 90.

The pulsed laser light incident on the spectrometer 90 may penetrate through the diffusion element 91 and be diffused. The pulsed laser light that has penetrated through the diffusion element 91 and has been diffused by the diffusion element 91 may be incident on the monitor etalon 92. The monitor etalon 92 may cause interference with the pulsed laser light incident on the monitor etalon 92.

The pulsed laser light having interference caused by the monitor etalon 92 may be incident on the condenser lens 93. The pulsed laser light incident on the condenser lens 93 may penetrate through the condenser lens 93 and generate a circular interference fringe on the focal plane of the condenser lens 93.

The pulsed laser light that has penetrated through the condenser lens 93 may be condensed to the image sensor 94. The image sensor 94 may be arranged on the focal plane of the condenser lens 93 and detect the circular interference fringe generated on the focal plane of the condenser lens 93. A signal corresponding to the interference fringe detected by the image sensor 94 may be transmitted to the wavelength controller 40.

The wavelength controller 40 may receive data of target wavelength λtx of pulsed laser light from the laser controller 110. The wavelength controller 40 may transmit, based on the data of the target wavelength λtx of the pulsed laser light, a signal for controlling the rotary stage 34 included in the line narrowing module 30 to the driver 50. Wavelength of the pulsed laser light may be selected by controlling the rotary stage 34 included in the line narrowing module 30 via the driver 50. The wavelength controller 40 may receive a signal transmitted from the optical sensor 80 and receive a signal corresponding to an interference fringe transmitted from the image sensor 94 of the spectrometer 90 included in the wavelength measuring unit 120. The wavelength controller 40 may calculate (measure) wavelength of the pulsed laser light from the data of the signal corresponding to the interference fringe.

2. Problems of Related Art Related to Laser Device According to Embodiment of Present Disclosure

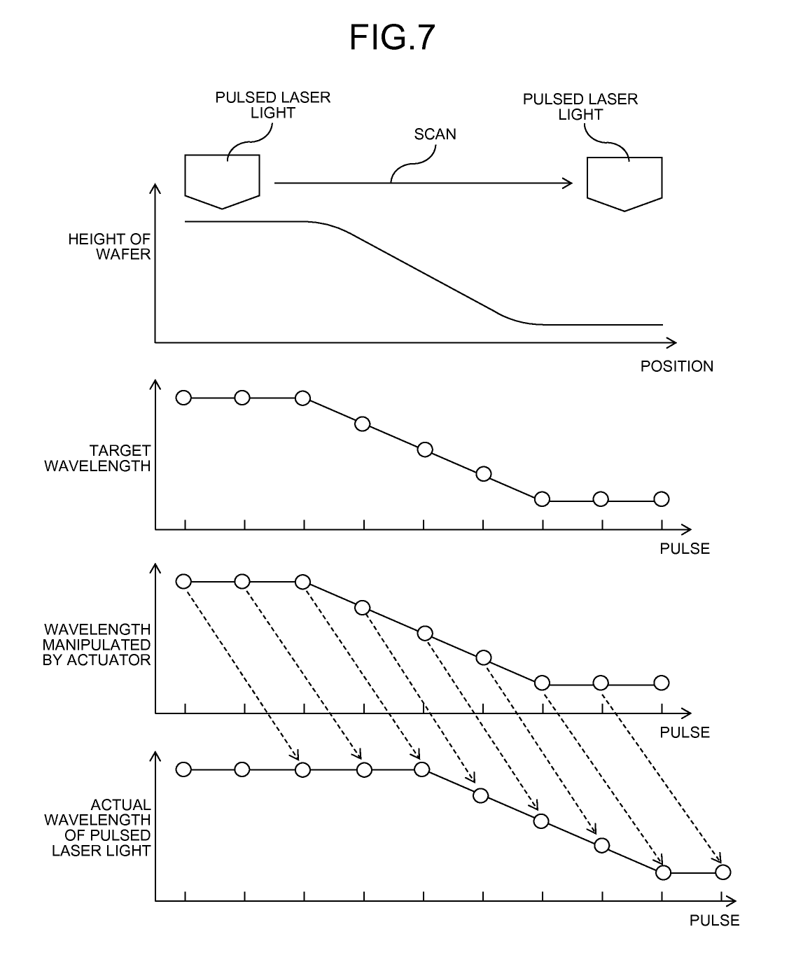

FIG. 7 is a diagram exemplifying problems of related art related to the laser device according to the embodiment of the present disclosure.

As exemplified in FIG. 7, when a surface of a wafer provided in an exposure device is exposed to and scanned by pulsed laser light, according to variation in height of the surface of the wafer with respect to position on the wafer, position of focus of the pulsed laser light can be changed. In order to change the position of the focus of the pulsed laser light, wavelength of pulsed laser light emitted from a laser device can be changed per laser pulse.

For example, as exemplified in FIG. 7, if the surface of the wafer provided in the exposure device has a slope, the slope on the surface of the wafer can be exposed to and scanned by pulsed laser light. When the slope on the surface of the wafer is exposed to and scanned by the pulsed laser light, data of target wavelength λtx per laser pulse transmitted to a laser controller of the laser device from an exposure device controller of the exposure device can vary according to height of the slope on the surface of the wafer.

According to the data of the target wavelength λtx that vary according to the height of the slope on the surface of the wafer, wavelength of pulsed laser light manipulated by an actuator included in the laser device can vary according to the height of the slope on the surface of the wafer. The wavelength of the pulsed laser light manipulated by the actuator included in the laser device can be, for example, wavelength of pulsed laser light, which should be achieved by rotation of a rotary stage included in a line narrowing module.

However, if a response time of the actuator included in the laser device is longer than a variation period of the data of the target wavelength λtx (for example, as exemplified in FIG. 7, by a time period corresponding to two pulses), actual wavelength of the pulsed laser light can become inconsistent with the target wavelength λtx. For example, if the response time of the actuator included in the laser device is longer than a predetermined cycle period of burst mode operation of the laser device (for example, 1/6000 second (repetition frequency of 6 kHz)), the actual wavelength of the pulsed laser light can become inconsistent with the target wavelength λtx. Even if the actuator included in the laser device is manipulated per laser pulse according to the data of the target wavelength λtx, the actual wavelength of the pulsed laser light can become inconsistent with the target wavelength λtx.

As described above, when the data of the target wavelength λtx per laser pulse is changed according to the variation in the height of the surface of the wafer, it can be difficult to control the laser device so as to make the actual wavelength of the pulsed laser light emitted from the laser device coincide with the target wavelength λtx.

3. Method of Controlling Wavelength of Laser According to Embodiment of Present Disclosure

3.1 Method of Controlling Wavelength of Laser According to First Embodiment of Present Disclosure

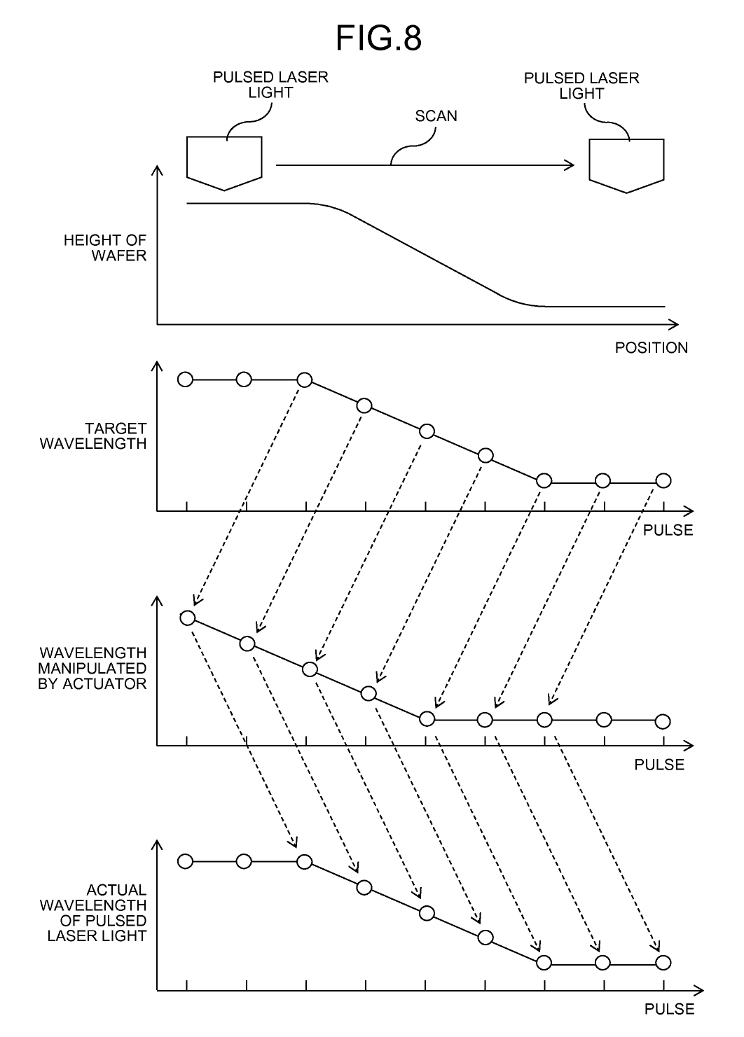

FIG. 8 is a diagram exemplifying an outline of a method of controlling wavelength of laser according to a first embodiment of the present disclosure.

As exemplified in FIG. 8, when a surface of a wafer provided in the exposure device 200 is exposed to and scanned by pulsed laser light, according to variation in height of the surface of the wafer with respect to position on the wafer, position of focus of the pulsed laser light may be changed. In order to change the position of the focus of the pulsed laser light, wavelength of pulsed laser light emitted from the laser device 100 may be changed per laser pulse.

For example, as exemplified in FIG. 8, if a surface of the wafer 300 provided in the exposure device 200 has a slope, the slope on the surface of the wafer 300 may be exposed to and scanned by pulsed laser light. When the slope on the surface of the wafer 300 is exposed to and scanned by pulsed laser light, data of target wavelength λtx per laser pulse transmitted from the exposure device controller 210 to the laser controller 110 can vary according to height of the slope on the surface of the wafer 300.

The wavelength controller 40 included in the laser device 100 may be configured to receive, from the exposure device controller 210, data of target wavelength λtx of pulsed laser light for a plurality of laser pulses before the pulsed laser light is output from the laser device 100. For example, the wavelength controller 40 may be configured to receive data of target wavelength λtx of pulsed laser light for a plurality of laser pulses before one burst of pulsed laser light is output. For example, the data of the target wavelength λtx of the pulsed laser light for the plurality of laser pulses may include data of target wavelength λtx for a plurality of pulses included in one burst of pulsed laser light.

The wavelength controller 40 may change wavelength of pulsed laser light manipulated by the actuator, dependently on the data of the target wavelength λtx that vary according to the height of the slope on the surface of the wafer 300 and the response time of the actuator included in the laser device 100. The wavelength of the pulsed laser light manipulated by the actuator included in the laser device 100 may be, for example, wavelength of the pulsed laser light that should be achieved by rotation of the rotary stage 34 included in the line narrowing module 30. The wavelength controller 40 may control, based on the variation in the height of the slope on the surface of the wafer 300 and the response time of the actuator, the actuator included in the laser device 100.

The wavelength controller 40 may be configured to change wavelength of the pulsed laser light manipulated by the actuator included in the laser device 100 prior to, by at least the response time of the actuator, a time point at which the target wavelength λtx of the pulsed laser light is changed.

The wavelength controller 40 may be configured to control the actuator, based on the data of the target wavelength λtx of the pulsed laser light for the plurality of laser pulses and the response time of the actuator included in the laser device 100. For example, the wavelength controller 40 may read out, dependently on the response time of the actuator included in the laser device 100, target wavelength λtx of the pulsed laser light prior by a plurality of laser pulses corresponding to the response time of the actuator. The wavelength controller 40 may change, according to the target wavelength λtx of the pulsed laser light prior by the plurality of laser pulses corresponding to the response time of the actuator, wavelength of the pulsed laser light manipulated by the actuator included in the laser device 100. For example, as exemplified in FIG. 8, target wavelength λtx of pulsed laser light prior by two pulses may be read out and the actuator may be controlled according to the target wavelength λtx of the pulsed laser light prior by the two pulses.

The wavelength controller 40 may be configured to control the actuator such that actual wavelength of the pulsed laser light emitted from the laser device 100 approaches the data of the target wavelength λtx. The actual wavelength of the pulsed laser light can be brought closer to the data of the target wavelength λtx by the wavelength controller 40 controlling the actuator according to the target wavelength λtx of the pulsed laser light prior by the plurality of laser pulses corresponding to the response time of the actuator. For example, as exemplified in FIG. 8, actual wavelength of the pulsed laser light can be brought closer to the data of the target wavelength λtx by the actuator being controlled according to the target wavelength λtx of the pulsed laser light prior by two pulses.

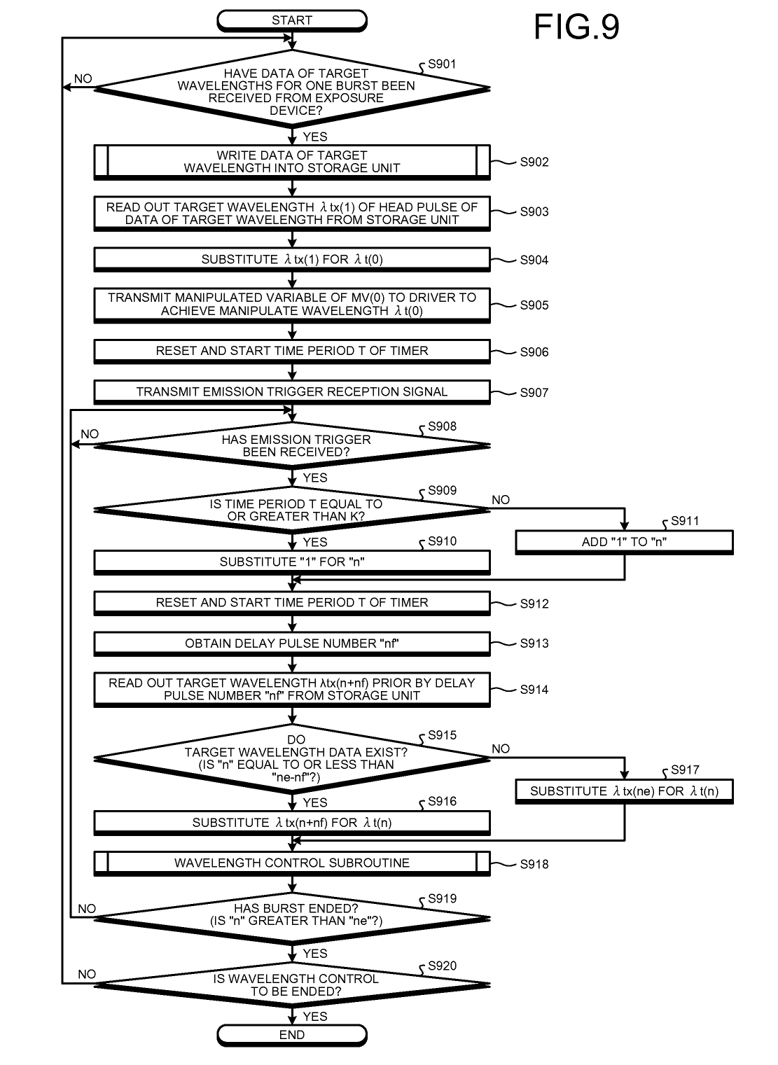

FIG. 9 is a diagram exemplifying a flow chart of the method of controlling wavelength of laser according to the first embodiment of the present disclosure.

At Step S901, the wavelength controller 40 included in the laser device 100 that performs burst mode operation may receive data of target wavelength λtx of pulsed laser light for respective laser pulses of one burst from the exposure device controller 210 via the laser controller 110. The data of the target wavelength λtx of the pulsed laser light for the respective laser pulses of the one burst may be a plurality of data λtx(1), . . . , λtx(n), . . . , λtx(ne) of target wavelength λtx for one burst including “ne” laser pulses from a head pulse to a final pulse. Here, λtx(n) may mean a target wavelength λtx of pulsed laser light for an n-th laser pulse from among the head pulse to the final pulse.

At Step S902, the wavelength controller 40 may write the plurality of data λtx(1), . . . , λtx(n), . . . , λtx(ne) of the target wavelength λtx for the one burst including the “ne” laser pulses, into the storage unit included in the wavelength controller 40.

At Step S903, the wavelength controller 40 may read out the target wavelength λtx(1) of the head pulse of that one burst.

At Step S904, the wavelength controller 40 may substitute the target wavelength λtx(1) of the head pulse for an initial wavelength λt(0) of pulsed laser light manipulated by the actuator.

At Step S905, the wavelength controller 40 may calculate an initial value MV(0) of an actuator manipulated variable corresponding to the initial wavelength λt(0) of the pulsed laser light manipulated by the actuator. The wavelength controller 40 may transmit the initial value MV(0) of the actuator manipulated variable to the driver 50 that controls the actuator, such that the wavelength of the pulsed laser light becomes the target wavelength λtx(1) of the head pulse. By the laser device 100 transmitting the initial value MV(0) of the actuator manipulated variable to the driver 50 beforehand during a stoppage period in the burst mode operation, the wavelength of the head pulse in the burst can be brought closer to the target wavelength λtx(1) of the head pulse.

At Step S906, the wavelength controller 40 may reset a time period T measured by the timer included in the wavelength controller 40 and start measurement of the time period T by the timer. The timer may monitor a time period of stoppage in the burst mode operation of the laser device 100.

At Step S907, the wavelength controller 40 may transmit an emission trigger reception signal to the exposure device controller 210 and prepare for receiving an emission trigger signal from the exposure device controller 210.

At Step S908, the wavelength controller 40 may execute determination of whether or not the laser controller 110 has received an emission trigger signal from the exposure device controller 210. If the laser controller 110 has received an emission trigger signal from the exposure device controller 210, Step S909 may be executed. If the laser controller 110 has not received an emission trigger signal from the exposure device controller 210, Step S908 may be repeated until the laser controller 110 receives an emission trigger signal from the exposure device controller 210.

At Step S909, the wavelength controller 40 may execute determination of whether or not the time period T measured by the timer is equal to or greater than a predetermined time period K. Determination of whether or not the time period of stoppage in the burst mode operation of the laser device 100 is equal to or greater than the predetermined time period K may be executed. If the time period of stoppage in the burst mode operation of the laser device 100 is equal to or greater than the predetermined time period K, the pulse of the pulsed laser light emitted from the laser device 100 may be determined to be a head pulse of a burst. If the time period of stoppage in the burst mode operation of the laser device 100 is equal to or greater than the predetermined time period K, Step S910 may be executed. If the time period of stoppage in the burst mode operation of the laser device 100 is less than the predetermined time period K, the pulse of the pulsed laser light emitted from the laser device 100 may be determined to be a pulse later than a head pulse of a burst. If the time period of stoppage in the burst mode operation of the laser device 100 is less than the predetermined time period K, Step S911 may be executed.

At Step S910, the wavelength controller 40 may substitute “1” for the laser pulse number “n”.

At Step S911, the wavelength controller 40 may add “1” to the laser pulse number “n”.

At Step S912, the wavelength controller 40 may reset the time period T measured by the timer included in the wavelength controller 40 and start measurement of the time period T by the timer. The timer may monitor time in a burst in burst mode operation of the laser device 100 by the measurement of the time period T.

At Step S913, the wavelength controller 40 may obtain a delay pulse number “nf” dependent on the response time of the actuator included in the laser device 100. The delay pulse number “nf” may be, for example, “2”.

At Step S914, the wavelength controller 40 may read out, from the storage unit, a target wavelength λtx(n+nf) of pulsed laser light corresponding to a laser pulse prior to a laser pulse of the laser pulse number “n” by the delay pulse number “nf”.

At Step S915, the wavelength controller 40 may determine whether or not data of the target wavelength λtx(n+nf) of the pulsed laser light exist. The wavelength controller 40 may determine whether or not the laser pulse number “n+nf” is equal to or less than the laser pulse number “ne” of the final pulse in the burst (whether or not the laser pulse number “n” is equal to or less than “ne−nf”). If the data of the target wavelength λtx(n+nf) of the pulsed laser light exist (the laser pulse number “n” is equal to or less than “ne−nf”), the wavelength controller 40 may execute Step S916. If the data of the target wavelength λtx(n+nf) of the pulsed laser light do not exist (the laser pulse number “n” is greater than “ne−nf”), the wavelength controller 40 may execute Step S917.

At Step S916, the target wavelength λtx(n+nf) of the pulsed laser light corresponding to the laser pulse number “n+nf” may be substituted for the wavelength λt(n) of the pulsed laser light manipulated by the actuator for the laser pulse of the laser pulse number “n”.

At Step S917, the target wavelength λtx(ne) of the pulsed laser light corresponding to the laser pulse of the laser pulse number “ne” may be substituted for the wavelength λt(n) of the pulsed laser light manipulated by the actuator for the laser pulse of the laser pulse number “n”. If the laser pulse number “n+nf” is greater than the number “ne” of the final pulse in the burst, the target wavelength λtx(ne) of the pulsed laser light corresponding to the final pulse in the burst may be substituted for the wavelength λt(n) of the pulsed laser light manipulated by the actuator.

At Step S918, the wavelength controller 40 may execute a wavelength control subroutine described later. By executing the wavelength control subroutine, the wavelength controller 40 may calculate a value MV(n) of the actuator manipulated variable corresponding to the wavelength λt(n) of the pulsed laser light manipulated by the actuator. By executing the wavelength control subroutine, the wavelength controller 40 may transmit the value MV(n) of the actuator manipulated variable to the driver 50 that controls the actuator, such that the wavelength of pulsed laser light becomes the target wavelength λtx(n) of the pulsed laser light. By the laser device 100 transmitting the value MV(n) of the actuator manipulated variable to the driver 50 beforehand in the burst mode operation, the wavelength of the pulsed laser light can be brought closer to the target wavelength λtx(n) of the pulsed laser light.

St Step S919, the wavelength controller 40 may determine whether or not the laser device 100 has ended the burst in the burst mode operation. The wavelength controller 40 may determine whether or not the laser pulse number “n” is greater than the laser pulse number “ne” of the final pulse in the burst. If the laser device 100 has ended the burst in the burst mode operation (the laser pulse number “n” is greater than the laser pulse number “ne” of the final pulse in the burst), Step S920 may be executed. If the laser device 100 has not ended the burst in the burst mode operation (the laser pulse number “n” is equal to or less than the laser pulse number “ne” of the final pulse in the burst), execution of Step S908 to Step S919 may be repeated.

At Step S920, the wavelength controller 40 may determine whether or not control of wavelength of the pulsed laser light is to be ended. If the control of the wavelength of the pulsed laser light is not to be ended, execution of Step S901 to Step S920 may be repeated.

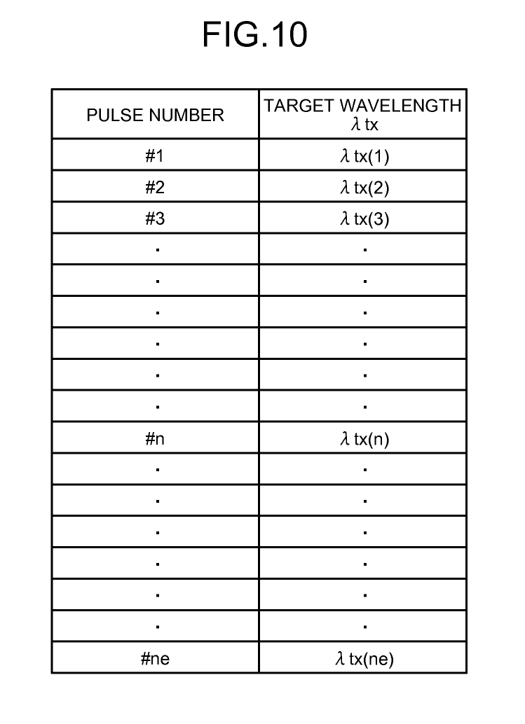

FIG. 10 is a diagram exemplifying data of target wavelength of pulsed laser light in the method of controlling wavelength of laser according to the first embodiment of the present disclosure.

As exemplified in FIG. 10, the data of the target wavelength λtx of the pulsed laser light transmitted from the exposure device controller 210 to the laser controller 110 may be configured of “ne” sets of: a pulse number #n; and a target wavelength λtx(n) of pulsed laser light corresponding to the pulse number #n. A set of a pulse number #1 and a target wavelength λtx(1) of pulsed laser light corresponding to the pulse number #1 may respectively be a laser pulse number of a head pulse in one burst, and a target wavelength λtx(1) of pulsed laser light of the head pulse in that one burst. A set of the pulse number #ne and the target wavelength λtx(ne) of pulsed laser light corresponding to the pulse number #ne may respectively be a laser pulse number of a final pulse in one burst, and a target wavelength λtx(ne) of pulsed laser light of the final pulse in that one burst.

The data of the target wavelength λtx of the pulsed laser light transmitted from the exposure device controller 210 to the laser controller 110 may be data for laser pulses included in a plurality of bursts for exposure of one wafer 300 with the pulsed laser light.

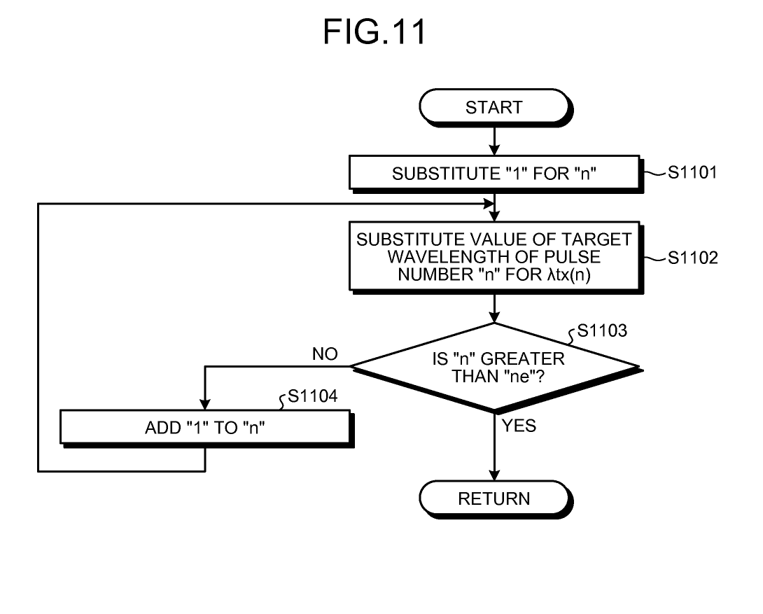

FIG. 11 is a diagram exemplifying a subroutine of writing data of target wavelength into a storage unit in the method of controlling wavelength of laser according to the first embodiment of the present disclosure.

At Step S1101, the wavelength controller 40 may substitute “1” for the laser pulse number “n”.

At Step S1102, the wavelength controller 40 may substitute a value of a target wavelength of pulsed laser light corresponding to the laser pulse number “n” transmitted from the exposure device controller 210 for the variable λtx(n).

At Step S1103, the wavelength controller 40 may determine whether or not the laser pulse number “n” is greater than the number of laser pulses “ne” (the number “ne” of the final pulse in one burst). If the laser pulse number “n” is greater than the number “ne” of laser pulses, the subroutine for writing the data of the target wavelength into the storage unit may be ended and return to a main routine may be performed. If the laser pulse number “n” is equal to or less than the number “ne” of laser pulses, Step S1104 may be executed.

At Step S1104, the wavelength controller 40 may add “1” to the laser pulse number “n” and return to Step S1102.

As described above, the wavelength controller 40 is able to write “ne” sets of: the pulse number #n; and the target wavelength λtx(n) of the pulsed laser light corresponding to the pulse number #n, into the storage unit.

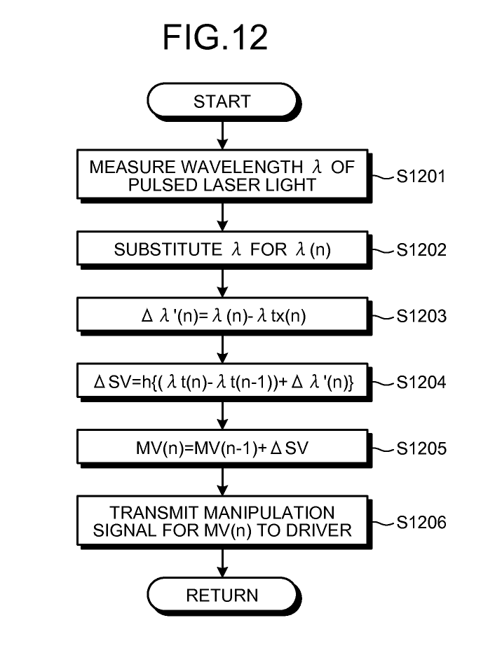

FIG. 12 is a diagram exemplifying a first example of a wavelength control subroutine in the method of controlling wavelength of laser according to the first embodiment of the present disclosure.

The first example of the wavelength control subroutine in the method of controlling wavelength of laser according to the first embodiment of the present disclosure exemplified in FIG. 12 may not include PID control.

At Step S1201, the wavelength measuring unit 120 may measure actual wavelength λ of pulsed laser light and transmit the measured wavelength λ to the wavelength controller 40.

At Step S1202, the wavelength controller 40 may substitute the measured wavelength λ for the actual wavelength λ(n) of the pulsed laser light for the laser pulse number “n”.

At Step S1203, the wavelength controller 40 may calculate a difference Δλ′ (n) between the actual wavelength λ(n) of the pulsed laser light for the laser pulse number “n” and the target wavelength λtx(n) for the laser pulse number “n” (Δλ′ (n)=λ(n)−λtx(n)).

At Step S1204, the wavelength controller 40 may calculate a variation value ΔSV of the actuator manipulated variable. The variation value ΔSV of the actuator manipulated variable may be calculated based on a difference between the wavelengths λt(n−1) and λt(n) of pulsed laser light manipulated by the actuator for laser pulses of numbers “n−1” and “n”, and Δλ′ (n). The variation value ΔSV of the actuator manipulated variable may be calculated by an equation, “ΔSV=h{(λt(n)−λt(n−1))+Δ′λ(n)}”. In this equation, “h” may be a coefficient for converting a wavelength of pulsed laser light to an actuator manipulated variable.

At Step S1205, the wavelength controller 40 may calculate the actuator manipulated variable MV(n) for the laser pulse number “n”. The actuator manipulated variable MV(n) for the laser pulse number “n” may be calculated based on an actuator manipulated variable MV(n−1) for the laser pulse of the laser pulse number “n−1” and the variation value ΔSV of the actuator manipulated variable.

At Step S1206, the wavelength controller 40 may transmit a signal of the actuator manipulated variable MV(n) for the laser pulse number “n” to the driver 50. The driver 50 may control the actuator based on the actuator manipulated variable MV(n) for the laser pulse number “n”.

As described above, the wavelength controller 40 may control the actuator based on a difference between data of target wavelength of pulsed laser light and wavelength of the pulsed laser light measured by the wavelength measuring unit.

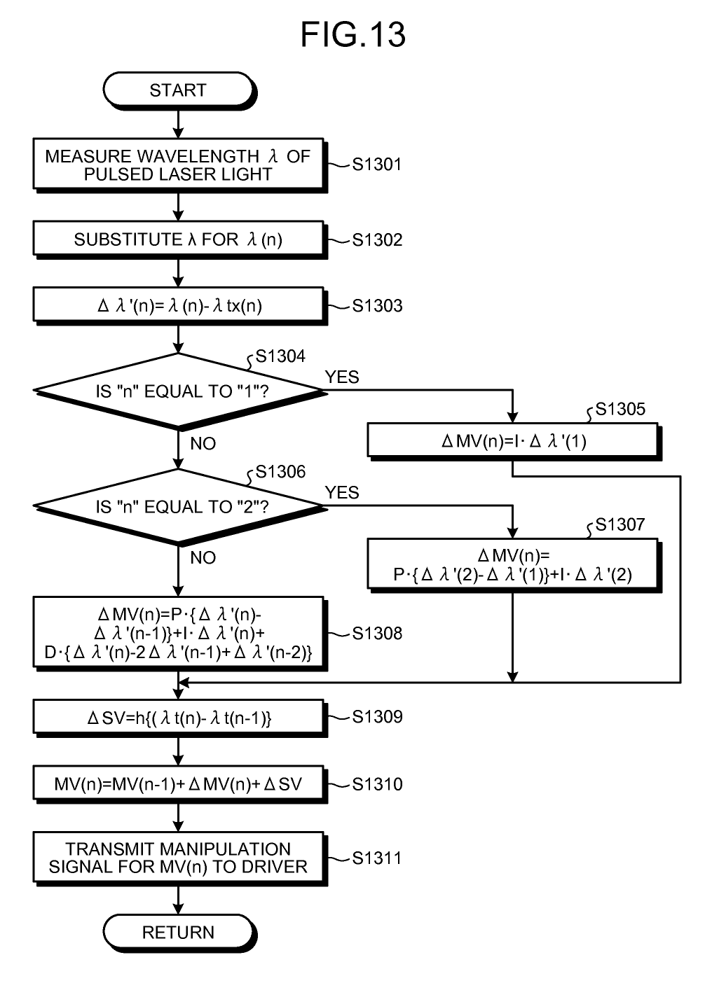

FIG. 13 is a diagram exemplifying a second example of the wavelength control subroutine in the method of controlling wavelength of laser according to the first embodiment of the present disclosure.

The second example of the wavelength control subroutine in the method of controlling wavelength of laser according to the first embodiment of the present disclosure exemplified in FIG. 13 may include PID control.

Step S1301 may be similar to Step S1201 exemplified in FIG. 12.

Step S1302 may be similar to Step S1202 exemplified in FIG. 12.

Step S1303 may be similar to Step S1203 exemplified in FIG. 12.

At Step S1304, the wavelength controller 40 may determine whether or not the laser pulse number “n” is “1”. If the laser pulse number “n” is “1”, the wavelength controller 40 may execute Step S1305. If the laser pulse number “n” is not “1”, the wavelength controller 40 may execute Step S1306.

At Step S1305, the wavelength controller 40 may calculate a PID control value ΔMV(n) for the actuator manipulated variable MV(n) for the laser pulse number “n”. The PID control value ΔMV(n) for the actuator manipulated variable MV(n) for the laser pulse number “n” may be calculated by an equation, “ΔMV(n)=I·Δλ′(1)”. In this equation, “I” may be a proportional constant in the PID control. This “I” may include a coefficient for converting a wavelength of pulsed laser light to an actuator manipulated variable. The “I” may be obtained beforehand by, for example, changing target wavelength of pulsed laser light in a step-like manner and measuring change in wavelength of the pulsed laser light.

At Step S1306, the wavelength controller 40 may determine whether or not the laser pulse number “n” is “2”. If the laser pulse number “n” is “2”, the wavelength controller 40 may execute Step S1307. If the laser pulse number “n” is not “2”, the wavelength controller 40 may execute Step S1308.

At Step S1307, the wavelength controller 40 may calculate the PID control value ΔMV(n) for the actuator manipulated variable MV(n) for the laser pulse number “n”. The PID control value ΔMV(n) for the actuator manipulated variable MV(n) for the laser pulse number “n” may be calculated by an equation, “ΔMV(n)=P·{Δλ′(2)−Δλ′(1)}+I·Δλ′(2)”. In this equation, “P” and “I” may be proportional constants in the PID control. These “P” and “I” may include coefficients for converting a wavelength of pulsed laser light to an actuator manipulated variable. The “P” and “I” may be obtained beforehand by, for example, changing target wavelength of pulsed laser light in a step-like manner and measuring change in wavelength of the pulsed laser light.

At Step S1308, the wavelength controller 40 may calculate the PID control value ΔMV(n) for the actuator manipulated variable MV(n) for the laser pulse number “n”. The PID control value ΔMV(n) for the actuator manipulated variable MV(n) for the laser pulse number “n” may be calculated by an equation, “ΔMV(n)=P·{Δλ′(n)−Δλ′(n−1)}+I·Δλ′(n)+D·{Δλ′(n)−2Δλ′(n−1)+Δλ′(n−2)}”. In this equation, “P”, “I”, and “D” may be proportional constants in the PID control. These “P”, “I”, and “D” may include coefficients for converting a wavelength of pulsed laser light to an actuator manipulated variable. The “P”, “I”, and “D” may be obtained beforehand by, for example, changing target wavelength of pulsed laser light in a step-like manner and measuring change in wavelength of the pulsed laser light.

At Step S1309, the wavelength controller 40 may calculate the variation value ΔSV of the actuator manipulated variable other than the PID control. The variation value ΔSV of the actuator manipulated variable other than the PID control may be calculated based on a difference between the wavelengths λt(n−1) and λt(n) of pulsed laser light manipulated by the actuator for the laser pulses of the numbers “n−1” and “n”. The variation value ΔSV of the actuator manipulated variable may be calculated by an equation, “ΔSV=h{λt(n)−λt(n−1)}”. In this equation, “h” may be a coefficient for converting a wavelength of pulsed laser light to an actuator manipulated variable.

At Step S1310, the wavelength controller 40 may calculate the actuator manipulated variable MV(n) for the laser pulse number “n”. The actuator manipulated variable MV(n) for the laser pulse number “n” may be calculated based on the actuator manipulated variable MV(n−1) for the laser pulse of the laser pulse number “n−1”, the PID control value ΔMV(n), and the variation value ΔSV of the actuator manipulated variable.

Step S1311 may be similar to Step S1206 exemplified in FIG. 12.

As described above, the wavelength controller 40 may control the actuator by the PID control based on the difference between the data of the target wavelength of the pulsed laser light and the wavelength of the pulsed laser light measured by the wavelength measuring unit. By the PID control based on the difference between the data of the target wavelength of the pulsed laser light and the wavelength of the pulsed laser light measured by the wavelength measuring unit, stability of control of wavelength of pulsed laser light with respect to change in target wavelength of the pulsed laser light can be improved.

The PID control may be control related to at least one of “P”, “I”, and “D”.

Control (feedback control) other than the PID control based on a difference Δλ′ (n) between an actual wavelength λ(n) of pulsed laser light for the laser pulse number “n” and the target wavelength λtx(n) for the laser pulse number “n” may be performed.

3.2 Method of Controlling Wavelength of Laser According to Second Embodiment of Present Disclosure

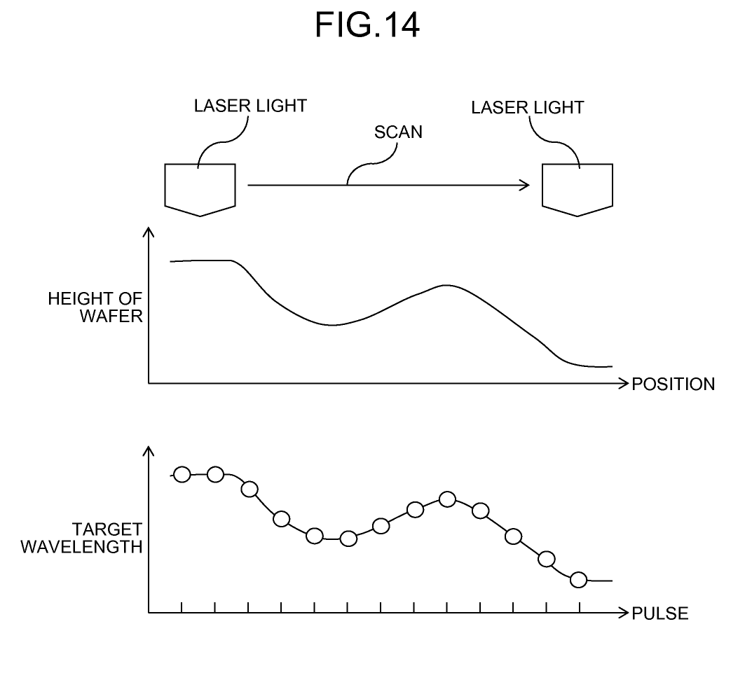

FIG. 14 is a diagram exemplifying an outline of a method of controlling wavelength of laser according to a second embodiment of the present disclosure.

As exemplified in FIG. 14, concavity and convexity may be present on a surface of the wafer 300 provided in the exposure device 200 in a scanning direction of pulsed laser light. The concavity and convexity present on the surface of the wafer 300 in the scanning direction of pulsed laser light may mean having at least one of a local maximum and a local minimum in height of the surface of the wafer 300 in the scanning direction of pulsed laser light.

As exemplified in FIG. 14, when the surface of the wafer 300 provided in the exposure device 200 is exposed to and scanned by pulsed laser light, according to the concavity and convexity on the surface of the wafer 300 with respect to position on the wafer 300, position of focus of the pulsed laser light may be changed. In order to change the position of the focus of the pulsed laser light, wavelength of pulsed laser light emitted from the laser device 100 may be changed per laser pulse.

For example, as exemplified in FIG. 14, if the concavity and convexity exist on the surface of the wafer 300 provided in the exposure device 200 in the scanning direction of pulsed laser light, the concavity and convexity on the surface of the wafer 300 may be exposed to and scanned by the pulsed laser light. When the concavity and convexity on the surface of the wafer 300 are exposed to and scanned by pulsed laser light, data of target wavelength λtx per laser pulse transmitted from the exposure device controller 210 to the laser controller 110 can vary according to the concavity and convexity on the surface of the wafer 300.

The wavelength controller 40 included in the laser device 100 may be configured to receive, from the exposure device controller 210, the data of target wavelength λtx of pulsed laser light for a plurality of laser pulses before pulsed laser light is output from the laser device 100.

The wavelength controller 40 may calculate a response time of the actuator included in the laser device 100 from the data of the target wavelength λtx that vary according to the concavity and convexity on the surface of the wafer 300. The response time of the actuator included in the laser device 100 may, for example, be calculated from a curvilinear relation of the target wavelength λtx that varies according to the concavity and convexity on the surface of the wafer 300 with respect to the position on the wafer 300 in the scanning direction of the pulsed laser light. As the response time of the actuator included in the laser device 100, a delay pulse number for each laser pulse may be calculated. The response time of the actuator included in the laser device 100 may vary according to the concavity and convexity on the surface of the wafer 300. Based on the response time of the actuator that varies according to the concavity and convexity on the surface of the wafer 300, wavelength of the pulsed laser light manipulated by the actuator may be changed. The wavelength controller 40 may control, based on the response time of the actuator that varies according to the concavity and convexity on the surface of the wafer 300, the actuator included in the laser device 100.

The wavelength controller 40 may be configured to change wavelength of pulsed laser light manipulated by the actuator included in the laser device 100 prior to a time point, at which target wavelength λtx of the pulsed laser light is changed, by at least the response time of the actuator.

The wavelength controller 40 may be configured to control the actuator, based on the response time of the actuator that varies according to the concavity and convexity on the surface of the wafer 300.

The wavelength controller 40 may be configured to control the actuator, such that actual wavelength of pulsed laser light emitted from the laser device 100 approaches data of the target wavelength λtx.

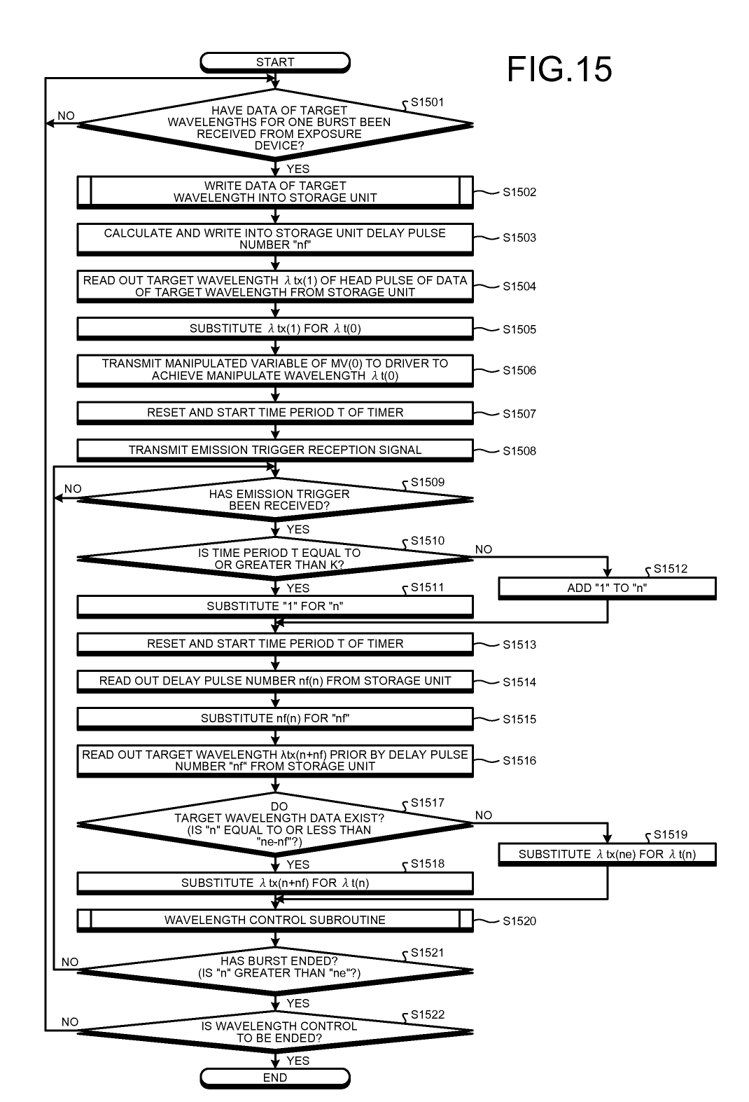

FIG. 15 is a diagram exemplifying a flow chart of the method of controlling wavelength of laser according to the second embodiment of the present disclosure.

Step S1501 may be similar to Step S901 exemplified in FIG. 9.

Step S1502 may be similar to Step S902 exemplified in FIG. 9.

At Step S1503, the wavelength controller 40 may calculate a delay pulse number “nf” for each pulse, based on data of target wavelength λtx that vary according to the concavity and convexity on the surface of the wafer in the scanning direction of the pulsed laser light. The wavelength controller 40 may write the delay pulse number “nf” calculated for each laser pulse into the storage unit included in the wavelength controller 40.

Step S1504 may be similar to Step S903 exemplified in FIG. 9.

Step S1505 may be similar to Step S904 exemplified in FIG. 9.

Step S1506 may be similar to Step S905 exemplified in FIG. 9.

Step S1507 may be similar to Step S906 exemplified in FIG. 9.

Step S1508 may be similar to Step S907 exemplified in FIG. 9.

Step S1509 may be similar to Step S908 exemplified in FIG. 9.

Step S1510 may be similar to Step S909 exemplified in FIG. 9.

Step S1511 may be similar to Step S910 exemplified in FIG. 9.

Step S1512 may be similar to Step S911 exemplified in FIG. 9.

Step S1513 may be similar to Step S912 exemplified in FIG. 9.

At Step S1514, the wavelength controller 40 may read out a delay pulse number nf(n) for a laser pulse of the laser pulse number “n” from the storage unit included in the wavelength controller 40.

At Step S1515, the wavelength controller 40 may substitute, for the delay pulse number “nf”, the delay pulse number nf(n) for the laser pulse of the laser pulse number “n”.

Step S1516 may be similar to Step S914 exemplified in FIG. 9.

Step S1517 may be similar to Step S915 exemplified in FIG. 9.

Step S1518 may be similar to Step S916 exemplified in FIG. 9.

Step S1519 may be similar to Step S917 exemplified in FIG. 9.

Step S1520 may be similar to Step S918 exemplified in FIG. 9.

Step S1521 may be similar to Step S919 exemplified in FIG. 9.

Step S1522 may be similar to Step S920 exemplified in FIG. 9.

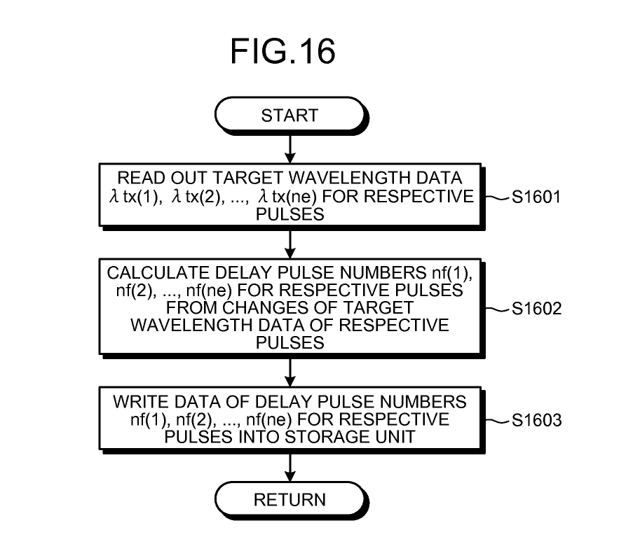

FIG. 16 is a diagram exemplifying a subroutine for calculating and writing, into a storage unit, a delay pulse number in the method of controlling wavelength of laser according to the second embodiment of the present disclosure.

At Step S1601, the wavelength controller 40 may read out the data of the target wavelength λtx of the pulsed laser light for respective laser pulses from the exposure device controller 210 via the laser controller 110. The data of the target wavelength λtx of the pulsed laser light for the respective laser pulses may be data λtx(1), . . . , λtx(n), . . . , λtx(ne) of target wavelength λtx of the pulsed laser light for “ne” laser pulses. Here, λtx(n) may mean a target wavelength λtx of pulsed laser light for an n-th laser pulse of the “ne” pulses.

At Step S1602, the wavelength controller 40 may calculate delay pulse numbers nf(1), . . . , nf(n), . . . , nf(ne) for the “ne” laser pulses from changes of the data λtx(1), . . . , λtx(n), . . . , λtx(ne) of the target wavelength λtx of the pulsed laser light with respect to the laser pulse number “n”. For example, the delay pulse numbers nf(1), . . . , nf(n), . . . , nf(ne) for the “ne” laser pulses may be calculated to be proportional to differential coefficients of an approximate curve of the data λtx(1), . . . , λtx(n), . . . , λtx(ne) of the target wavelength λtx of the pulsed laser light with respect to the laser pulse number “n”.

At Step S1603, the wavelength controller 40 may write the data of the delay pulse numbers nf(1), . . . , nf(n), . . . , nf(ne) calculated for the “ne” laser pulses into the storage unit included in the wavelength controller 40.

3.3 Method of Controlling Wavelength of Laser According to Third Embodiment of Present Disclosure

The exposure device controller 210 included in the exposure device 200 may receive a delay pulse number of a laser pulse according to a response time of the actuator included in the laser device 100 beforehand from the laser controller 110 included in the laser device 100. The laser controller 110 may receive, for each laser pulse, a laser pulse number “n”, a target wavelength λtx(n) of pulsed laser for a laser pulse of the laser pulse number “n”, and a wavelength λt(n) for manipulating the actuator. In this way also, actual wavelength of pulsed laser light emitted from the laser device 100 can be controlled similarly.

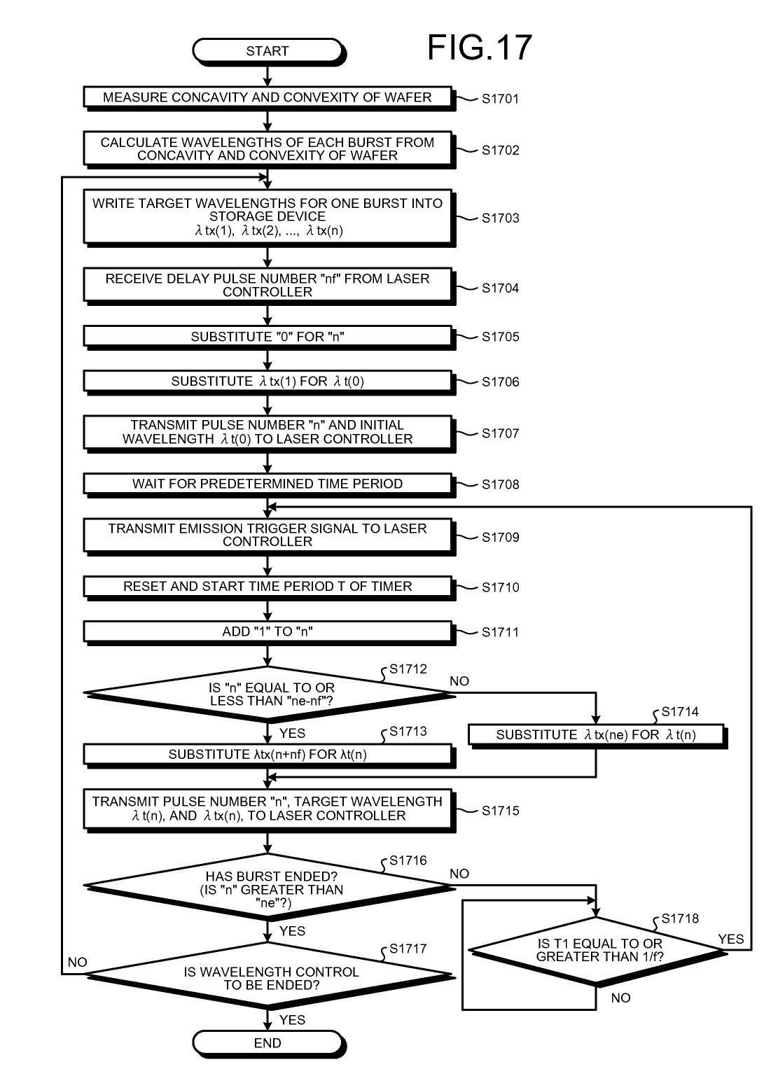

FIG. 17 is a diagram exemplifying a flow chart for an exposure device controller in a method of controlling wavelength of laser according to a third embodiment of the present disclosure.

At Step S1701, the exposure device controller 210 may measure concavity and convexity on a surface of the wafer 300 provided in the exposure device 200.

At Step S1702, the exposure device controller 210 may calculate, per laser pulse, based on measured values of the concavity and convexity on the surface of the wafer 300, wavelength of pulsed laser light that should be emitted from the laser device 100 performing burst mode operation.

At Step S1703, the exposure device controller 210 may write data λtx(1), . . . , λtx(n) of target wavelength λtx of pulsed laser light for “n” laser pulses included in one burst into the storage device included in the exposure device controller 210.

At Step S1704, the exposure device controller 210 may receive a delay pulse number “nf” for a laser pulse of pulsed laser light from the laser controller 110 included in the laser device 100. The delay pulse number “nf” for the laser pulse of the pulsed laser light may be dependent on a response time of the actuator included in the laser device 100.

At Step S1705, the exposure device controller 210 substitutes “0” for the laser pulse number “n” of pulsed laser light.

At Step S1706, the exposure device controller 210 may substitute a target wavelength λtx(1) of pulsed laser light for a first laser pulse (head pulse) for an initial wavelength λt(0) of the pulsed laser light manipulated by the actuator.

At Step S1707, the exposure device controller 210 may transmit the laser pulse number “n” (=0) of the laser pulse of the pulsed laser light and the initial wavelength λt(0) of the pulsed laser light manipulated by the actuator to the laser controller 110 included in the laser device 100.

At Step S1708, the exposure device controller 210 may wait for a predetermined time period (for example, a stoppage period in burst mode operation of the laser device 100).

At Step S1709, the exposure device controller 210 transmits an emission trigger signal Str to the laser controller 110 included in the laser device 100.

At Step S1710, the exposure device controller 210 may reset a time period T measured by the timer included in the exposure device controller 210 and start measurement of the time period T by the timer. The timer may monitor time intervals of laser pulses included in a burst in the burst mode operation of the laser device 100 by the measurement of the time period T.

At Step S1711, the exposure device controller 210 may add “1” to the laser pulse number “n” of pulsed laser light.

At Step S1712, the exposure device controller 210 may determine whether or not data of a target wavelength λtx(n+nf) of pulsed laser light exist. The exposure device controller 210 may determine whether or not a laser pulse number “n+nf” is equal to or less than the laser pulse number “ne” of the final pulse in the burst (whether or not the laser pulse number “n” is equal to or less than “ne−nf”). If the data of the target wavelength λtx(n+nf) of pulsed laser light exist (the laser pulse number “n” is equal to or less than “ne−nf”), the exposure device controller 210 may execute Step S1713. If the data of the target wavelength λtx(n+nf) of pulsed laser light do not exist (the laser pulse number “n” is greater than “ne−nf”), the exposure device controller 210 may execute Step S1714.

At Step S1713, the target wavelength λtx(n+nf) of pulsed laser light corresponding to the laser pulse of the laser pulse number “n+nf” may be substituted for the wavelength λt(n) of the pulsed laser light manipulated by the actuator for the laser pulse of the laser pulse number “n”.

At Step S1714, the target wavelength λtx(ne) of pulsed laser light corresponding to a laser pulse of a laser pulse number “ne” may be substituted for the wavelength λt(n) of the pulsed laser light manipulated by the actuator for the laser pulse of the laser pulse number “n”.

At Step S1715, the exposure device controller 210 may transmit, for each laser pulse, the laser pulse number “n”, the target wavelength λtx(n) of the pulsed laser for the laser pulse of the laser pulse number “n”, and the wavelength λt(n) for manipulating the actuator, to the laser controller 110.

At Step S1716, the exposure device controller 210 may determine whether or not the burst in the burst mode operation has been ended by the laser device 100. The exposure device controller 210 may determine whether or not the laser pulse number “n” is greater than the laser pulse number “ne” of the final pulse in the burst. If the laser device 100 has ended the burst in the burst mode operation (the laser pulse number “n” is equal to the laser pulse number “ne” of the final pulse in the burst), Step S1717 may be executed. If the laser device 100 has not ended the burst in the burst mode operation (the laser pulse number “n” is not equal to the laser pulse number “ne” of the final pulse in the burst), Step S1718 may be executed.

At Step S1717, the exposure device controller 210 may determine whether or not the control of the wavelength of the pulsed laser light is to be ended. If the control of the wavelength of the pulsed laser light is not to be ended, execution of Step S1703 to Step S1718 may be repeated.

At Step S1718, the exposure device controller 210 may determine whether or not the time period T1 measured by the timer is equal to or greater than a cycle period 1/f of laser pulses included in a burst. Here, “f” may be a repetition frequency of laser pulses included in a burst in burst mode operation of the laser device 100. If the time period T measured by the timer is equal to or greater than the cycle period 1/f of the laser pulses included in the burst, the exposure device controller 210 may repeat execution of Step S1709 to Step S1718. If the time period T measured by the timer is less than the cycle period 1/f of the laser pulses included in the burst, Step S1718 may be repeated until the time period T measured by the timer reaches the cycle period 1/f of the laser pulses included in the burst.

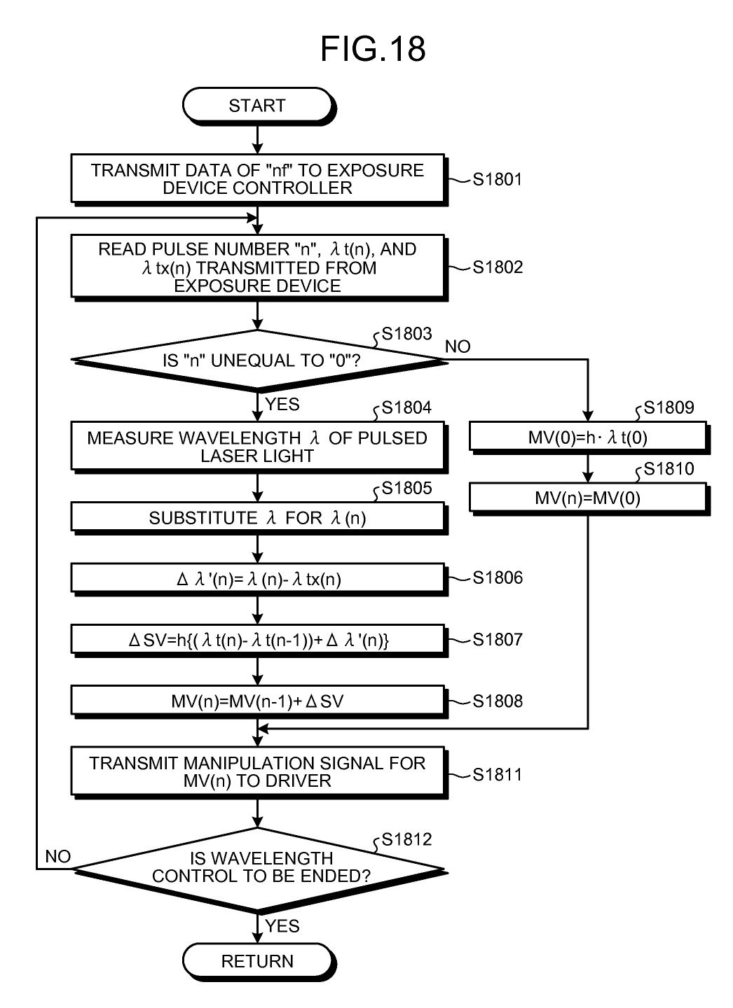

FIG. 18 is a diagram exemplifying a flow chart for a wavelength controller in the method of controlling wavelength of laser according to the third embodiment of the present disclosure.

At Step S1801, the wavelength controller 40 included in the laser device 100 may transmit, via the laser controller 110, the delay pulse number “nf” for the laser pulse of the pulsed laser light to the exposure device controller 210 included in the exposure device 200. The delay pulse number “nf” for the laser pulse of the pulsed laser light may be dependent on a response time of the actuator included in the laser device 100.

At Step S1802, the wavelength controller 40 may receive, for each laser pulse, via the laser controller 110, the laser pulse number “n”, the target wavelength λtx(n) of the pulsed laser for the laser pulse of the laser pulse number “n”, and the wavelength λt(n) for manipulating the actuator, from the exposure device controller 210.

At Step S1803, the wavelength controller 40 may determine whether or not the laser pulse number “n” is unequal to “0”. If the laser pulse number “n” is unequal to “0”, the wavelength controller 40 may execute Step S1804. If the laser pulse number “n” is “0”, the wavelength controller 40 may execute Step S1809 and Step S1810.

Step S1804 may be similar to Step S1201 exemplified in FIG. 12.

Step S1805 may be similar to Step S1202 exemplified in FIG. 12.

Step S1806 may be similar to Step S1203 exemplified in FIG. 12.

Step S1807 may be similar to Step S1204 exemplified in FIG. 12.

Step S1808 may be similar to Step S1205 exemplified in FIG. 12.

At Step S1809, the wavelength controller 40 may calculate an initial value MV(0) of the actuator manipulated variable corresponding to an initial wavelength λt(0) of pulsed laser light manipulated by the actuator. The initial value MV(0) of the actuator manipulated variable may be calculated by “MV(0)=h·λt(0)”. In this equation, “h” may be a coefficient for converting a wavelength of pulsed laser light to an actuator manipulated variable.

At Step S1810, the wavelength controller 40 may substitute the initial value MV(0) of the actuator manipulated variable for the actuator manipulated variable MV(n) for the laser pulse number “n”.

Step S1811 may be similar to Step S1206 exemplified in FIG. 12.

At Step S1812, the wavelength controller 40 may determine whether or not the control of the wavelength of the pulsed laser light is to be ended. If the control of the wavelength of the pulsed laser light is not to be ended, execution of Step S1802 to Step S1812 may be repeated.

The above description is intended for mere illustration of examples and not for limitation. Therefore, it should be evident to those skilled in the art that modifications may be made to the embodiments of the present disclosure without departing from scope of the appended patent claims.

Terms used throughout the present specification and the appended patent claims should be interpreted as “non-limiting” terms. For example, a term like “to include” or “to be included” should be interpreted as “not being limited to those described as being included”. A term “having” should be interpreted as “not being limited to those described as being had”. Further, an indefinite article “a” described in the present specification and the appended patent claims should be interpreted as meaning “at least one of” or “one or more of”.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A laser device (100), including:
a laser resonator (20, 30) configured to output pulsed laser light (L);
an actuator (35, 36, 37) configured to change wavelength of the pulsed laser light; and
a controller (110) configured to receive data of target wavelength for a plurality of pulses of the pulsed laser light before the pulsed laser light is output and to control the actuator, based on the data of the target wavelength for the plurality of pulses, such that the wavelength of the pulsed laser light approaches the data of the target wavelength.

2. The laser device according to claim 1, wherein the controller is configured to receive the data of the target wavelength for the plurality of pulses of the pulsed laser light before a burst of the pulsed laser light is output.

3. The laser device according to claim 2, wherein the data of the target wavelength for the plurality of pulses of the pulsed laser light include data of target wavelength for a plurality of pulses included in the burst of the pulsed laser light.

4. The laser device according to claim 1, further comprising a wavelength measuring unit (120) configured to measure wavelength of the pulsed laser light, wherein
the controller is configured to control the actuator based on the wavelength measured by the wavelength measuring unit.

5. The laser device according to claim 4, wherein the controller is configured to control the actuator, based on a difference between the data of the target wavelength and the wavelength measured by the wavelength measuring unit.

6. A method of controlling an actuator (35, 36, 37) configured to change wavelength of pulsed laser light (L), the method including:
changing wavelength of the pulsed laser light dependently on a response time of the actuator prior to, by at least the response time, a time point at which target wavelength of the pulsed laser light is changed.
